(19) United States
(12) Patent Application Publication
(10) Pub. No.: US 2022/0326596 A1
(43) Pub. Date: Oct. 13, 2022

(54) IMAGING SYSTEM FOR FIREARM

(71) Applicant: FN HERSTAL S.A., Herstal (BE)

(72) Inventors: François Legras, Jalhay (BE); Thomas C. Phillips, Alexandria, VA (US); Thomas Smith, Chester, VA (US)

(21) Appl. No.: 17/640,085

(22) PCT Filed: Sep. 10, 2020
(86) PCT No.: PCT/EP2020/075390

§ 371 Date: Mar. 3, 2022

Related U.S. Application Data
(60) Provisional application No. 62/898,260, filed on Sep. 10, 2019.

(51) Int. Cl. G03B 29/00; F41G 3/26; F41G 3/14

(52) U.S. Cl. CPC G03B 29/00; F41G 3/2605; F41G 3/142

(57) ABSTRACT

Embodiments of a firearm device (15) and system employ enhanced optics that can be fixed to a firearm (20), wherein each optical unit is optimized for varying distances from the firearm. An image processor interleaves video streams from each optical unit to present the operator with a unified field of view. Object recognition functions executed by a processor integrated with the device can evaluate the individual video streams, applying object recognition applications to recognize and identify threats/targets within the effective range of each optical unit/image sensor, enabling, among other things, real-time, rapid target identification across multiple distances and prioritization.

### FIELD OF THE INVENTION

The present disclosure relates generally to firearms, and more particularly to a firearm and system employing enhanced optics.

Particular embodiments of the disclosure are related to systems and methods for improving training of marksmanship.

### BACKGROUND OF THE INVENTION

Law enforcement and military training, operations and logistics applications all require weapon capabilities which deliver an accurate measurement of the weapon orientation and point of aim; a recognition of “shot break” and the intended target; a linkage of weapon telemetry data to the individual pulling the trigger and the ability to move telemetry data off of the weapon to local and/or central data repositories. Successfully supporting the four imperatives above requires advanced technologies as disclosed herein, which tailor form to functional requirements and leverage foundational capabilities to create new, previously unachievable capabilities.

The firearm and system of the present disclosure addresses a range of foundational challenges. For example, with respect to optics, law enforcement and military personnel require optics which can “recognize” multiple threat/targets at varying physical distances and orientations. Once the threat/target is identified, the capability must support “indexing” which assigns priority to each target in terms of risk. The optics must be able to deal with threats/targets presented on the oblique, partially obscured and in low light conditions.

With respect to moving target engagement, weapons skill development (e.g., basic rifle marksmanship) has traditionally relied on training a static shooter to hit a static target at a known distance. Unfortunately, threats do not generally stand still in a fight. Real world weapon engagements frequently occur with both the law enforcement/military personnel moving, as well as the threat actor. To be fully effective, a weapon system must support recognition of threat/target movement (direction and speed), but current systems do not.

With regard to predictive metrics related to marksmanship training, it is currently extremely expensive for law enforcement and military to transport weapon operators to qualification events. Unfortunately, significant numbers of personnel fail to qualify with their assigned weapons. Law enforcement and the military lack an objective mechanism to screen personnel to evaluate their likelihood of qualifying prior to being transported to qualification events.

With regard to optic zeroing, it is well understood that, when installed on a weapon, the optical unit must align with the bore of the weapon. Adjustment must occur in a manner which is easily executed by the operator and must remain fixed/stable during prolonged use during live fire.

Form factor is another issue, as the service weapon for law enforcement is typically a pistol. Adding an optical unit to a pistol requires a form factor which 1) will still fit inside a standard holster; and 2) avoids displacing the pistol flashlight which is typically mounted on the Picatinny rail attachment point. Further, weight must be considered, as attaching an external optical unit, particularly one requiring on-board power, such as a battery having sufficient longevity, must not add so much weight that it affects usage. In addition, the optical unit must be rugged enough to work on pistols, rifles, carbines and automatic rifles.

In addition to the above, law enforcement and the military have limited resources for capability acquisition. However, it is common to see unique, unrelated systems procured to separately support training, operational use and logistics applications. As a result, training may not accurately reflect operational environments (negative training), operational capabilities may not be regularly exercised, and the logistics community may not receive accurate information relevant to supporting law enforcement/military personnel in the field.

Supporting the movement of the telemetry data to a wide range of local devices, training and operational data become useful for a wide range of applications, including logistics.

### SUMMARY OF THE INVENTION

In order to address the problem of identifying targets at varying distances, the presently disclosed device and method integrates multiple optical units/sensors which are optimized for target identification and/or engagement at varying distances from the weapon. The image processor associated with the present system can advantageously interleave video streams from each optical unit to incorporate concurrent target identification at multiple ranges/distances to present the operator with unified target identification within the field of view. In the background, object recognition capability can preferably evaluate the individual video streams, applying object recognition applications to recognize and identify threats/targets within the effective range of each optical unit/image sensor. This enables real-time, rapid target identification across multiple distances and prioritization based upon the object recognition algorithm.

Preferably, the object recognition algorithm is based upon a machine learning algorithm.

Advantageously, the presently disclosed device, system and method leverage video generated from each optical unit/sensor to define threat/target movement. Advantageously, the system handles the treatment of relative movements of threat/target by quantifying (frame-by-frame) the relative movement of the threat/target in relation to the operator's point of aim. This onboard capability provides the operator with information on the direction and speed of movement of the threat/target, thereby enabling calculation of an appropriate “lead” within the point of aim to support accurate target engagement.

In addressing marksmanship training, the presently disclosed device, system and method preferably leverage the weapon operator's dry-fire performance to accurately predict the outcome during live-fire qualification events. Preferably, the system can accurately predict qualification scores on existing ranges based on as few as ten dry-fire shots.

Preferably, the device, system and method of the invention provide a novel external and/or a unique internal optic zeroing capability. Both capabilities deliver the ability to align the unit with the bore of the weapon. Independently and/or together, they provide the ability to provide a rugged, enduring alignment.

Advantageously, the device, system and method of the invention constrain the form factor of the device to ensure that it fits within a standard pistol (handgun) holster. To avoid displacing the pistol flashlight, the present device incorporates both visible and invisible illumination and pointers. Further, the device and system accommodate batteries providing sufficient continuous usage and are rugged enough to work on rifles, carbines and automatic rifles.

Advantageously, the system, device and method according to the invention create a common hardware/firmware/software solution which supports training, operations and logistics applications. Preferably, the capture and interpretation of telemetry data is “agnostic” and is moved from the optical unit to a local device, such as one or more smart phones or other computing devices, one or more head mounted displays (e.g., augmented reality and/or Head-Up display) and/or local data stores which can communicate with the enterprise. By configuring the optical unit for “permanent” attachment to a weapon, weight/balance becomes part of the expectation during training and operations.

Object recognition can be based on recognition of predetermined shaped targets/threats in case of training conditions (i.e. the training uses predetermined scenarios wherein the trainer organization knows the targets/threat upfront). Alternatively, it can be based upon body recognition, such as, for example, described in the article of Ke Sun et Al. “Deep high-resolution representation learning for human pose estimation” in Proceedings of the IEEE Conference on Computer Vision and Pattern Recognition, pages 5693-5703, 2019. In this latter case, depending on the part of the body of the point of aim, a lethality estimation can be performed in real-time. This estimation can for example be used to enable or disable the possibility of shooting. This can for example be used in less lethal weapons used by law enforcement officials.

Advantageously, the present device, system and method can take advantage of data streams from the weapon system (e.g., fire control, optics and other sensors) to collect large volumes of data on every shot taken (e.g., who is taking the shot (biometrics), shooter location, speed of magazine change, position, meteorological data, target type, speed/direction of target, type of weapon, type of round, shot trace, hit/miss, score, lethality calculation, etc.). Preferably, the presently disclosed device and system can support emerging technological advancements which require integration of new sensors, a head mounted display (e.g., HMD/goggles) and/or smart phones/personal digital assistants used by law enforcement and the military. Integration of these capabilities in association with current and next generation squad weapons enables new training operational and logistics applications.

Embodiments of the present disclosure employ enhanced optics on a firearm to support training and effective use. In various embodiments, hardware elements include advanced optics to support multi-target identification and recognition, moving target engagement for training (with dry fire and/or live fire), augmented reality training, and external and internal optical device zeroing.

Embodiments of the present disclosure assist with law enforcement marksmanship training using their service pistol, enabling practice of drawing the weapon, engaging targets and returning the weapon to the holster.

Embodiments of the present disclosure further assist with supporting the use of pistols in conventional and special operations of military environments. In various embodiments, the same system used for the pistol form factor can be employed to support close quarters battle and marksmanship applications, using a rifle or carbine, at ranges up to eighty meters, for example. Embodiments of the present disclosure further support weapon tracking to enable augmented reality marksmanship training. Embodiments of the present disclosure further enable the exchange of data with a central data repository, creating a persistent, detailed record of a shooter's performance over time. Embodiments of the present disclosure further provide instructional tools to measure shooter performance and recommend strategies and drills to enhance skill. These tools can reduce the requirement for skilled staff, enhance consistency of performance measures and provide leadership with objective reports on efforts to improve marksmanship.

Embodiments of the presently disclosed design utilize a camera-based imaging device to recognize a target and provide accurate measurement of shooter performance and enable intelligent tutoring through the use of built-in tools. Camera-based technologies enable moving target engagement, and target engagement at an extremely close range. This provides a dry-fire close quarters battle capability.

The present invention discloses a method for analyzing a firearm shot, comprising the steps of:
i. providing a firearm comprising a camera-based imaging device and a computer processor;
ii. recording images in the direction of the point of aim of the firearm;
iii. recognizing one or more targets via the imaging device.
iv. analyzing the correspondence between the recognized target and the point of aim at the time of a shot.

According to preferred embodiments, the method of the present invention comprises one or more of the following features:
the camera-based imaging device comprises at least two optical sensors having lenses of different focal length for acquiring images in the direction of the point of aim having a different field of view, the method further comprising the step of interleaving video streams originating from the at least two optical sensors, preferably, one optical sensor records a wide angle field of view for identifying a short range target, and another optical sensor having a small angle field of view for identifying a long range target;
the method further comprising the step of recording the movement of the point of aim relative to the target prior and after the detection of a shot;
the method comprising the step of communicating real-time data to a head-up display, said real-time data comprising at least one of data selected from the group consisting of: point of aim, recognized target, target speed, target orientation, target scale factor, target range estimation, appropriate lead taking into account target speed, and lethality of the current point of aim;
the method further comprising the step of collecting additional data on every detected shot, said data being related to an operator of the firearm, one or more of said data being selected from the group consisting of: location and movement of the firearm, speed of magazine changes, orientation, meteorological data, target type, speed/direction of target, type of weapon, type of round, shot trace, hit/miss, score, intended target, and lethality calculation;
the method comprising the step of quantifying relative movement of the target in relation to the point of aim of the firearm, and calculating the appropriate lead within the point of aim to support accurate moving target engagement;
the method comprising the step of detecting the occurrence of a shot, and determining the point of impact on the recognized target, by calculation of the ballistic and/or by determining the point of impact of a bullet;
the method further comprising the step of aligning the optical sensor axis with the bore axis by using a comparison between the calculated point of impact with the point of impact of the bullet;
the method comprising the step of communicating the recorded images to at least one remote device, said remote device being used to communicate performance of a user of the firearm;
the step of acquiring a target is based on the recognition of predetermined shapes in training conditions;
the step of acquiring a target is based on a human body pose determination algorithm;
the method being used in a training environment;
the method further comprising the step of switching the camera-based imaging device and the computer processor upon detection of predetermined action of a user of the firearm, such as getting a handgun out of a holster or removing a safety feature.

Another aspect of the invention is related to a firearm shot analysis system comprising:
a camera-based imaging device comprising fastening means to a firearm;
a computer processor, power supply and memory for recording the images acquired by the camera-based imaging device; and
a computer-readable memory and program instructions encoded by the computer-readable memory for making the processor, when executed, perform the method according to the method of the invention.

According to preferred embodiments, the system of the present invention comprises one or more of the following features:
the imaging device comprising multiple optical units/sensors;
the system comprising wireless communication means;
the system comprising an inertial measurement unit that collects the weapons movement, shot break detection and analysis;
the system comprising localization means such as GPS;
the fastening means being compatible with the Picatinny standard (STANAG 2324 or STANAG 4694);

Another aspect of the invention is related to a firearm comprising the system according the invention.

Preferably, the firearm is a handgun fitting in a standard handgun holster.

In a preferred alternative, the firearm is an automatic rifle.

### BRIEF DESCRIPTION OF THE DRAWINGS

FIG. 1 is an illustration of different firearms employing hardware in accordance with embodiments of the present disclosure.

FIG. 2 shows a front perspective view of optics hardware secured to a firearm in accordance with embodiments of the present disclosure.

FIG. 3 shows a side view of optics hardware secured to a firearm in accordance with embodiments of the present disclosure.

FIGS. 4 and 5 show views of two optics and batteries within an enclosure in accordance with embodiments of the present disclosure.

FIG. 6 shows a top view of a rigid-flex printed circuit board (PCB) configuration in accordance with embodiments of the present disclosure.

FIG. 7 shows the rigid-flex printed circuit board (PCB) after folding (the optics are represented in dotted line).

FIG. 8 shows the PCB of FIGS. 6 and 7 assembled with the optics.

FIGS. 9 and 10 show diagrams of small moving target engagement algorithms that can be employed in accordance with embodiments of the present disclosure.

FIG. 11 shows diagrams of moving target engagement algorithms that can be employed in accordance with embodiments of the present disclosure.

FIG. 12 shows diagrams of large moving target engagement algorithms that can be employed in accordance with embodiments of the present disclosure.

FIG. 13 shows an overview of an augmented reality architecture in accordance with embodiments of the present disclosure.

FIGS. 14 and 15 show views of an external gimbaled worm gear design for external zeroing in accordance with embodiments of the present disclosure.

FIG. 16 shows an exploded view of an external gimbaled worm gear design for external zeroing in accordance with embodiments of the present disclosure.

FIGS. 17 and 18 show views of a design for internal zeroing in accordance with embodiments of the present disclosure.

FIG. 19 is a schematic diagram of computing elements in accordance with embodiments of the present disclosure.

FIG. 20 is a process flow diagram illustrating processes in accordance with embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

More specifically, the present disclosure encompasses any suitable combinations of embodiments described herein separately.

Example embodiments such as disclosed herein can incorporate a controller having a processor and an associated memory storing instructions that, when executed by the processor, cause the processor to perform operations as described herein. It will be appreciated that reference to “a”, “an” or other indefinite article in the present disclosure encompasses one or more than one of the described element. Thus, for example, reference to a processor encompasses one or more processors, reference to a memory encompasses one or more memories, reference to an optic device encompasses one or more optic devices and so forth.

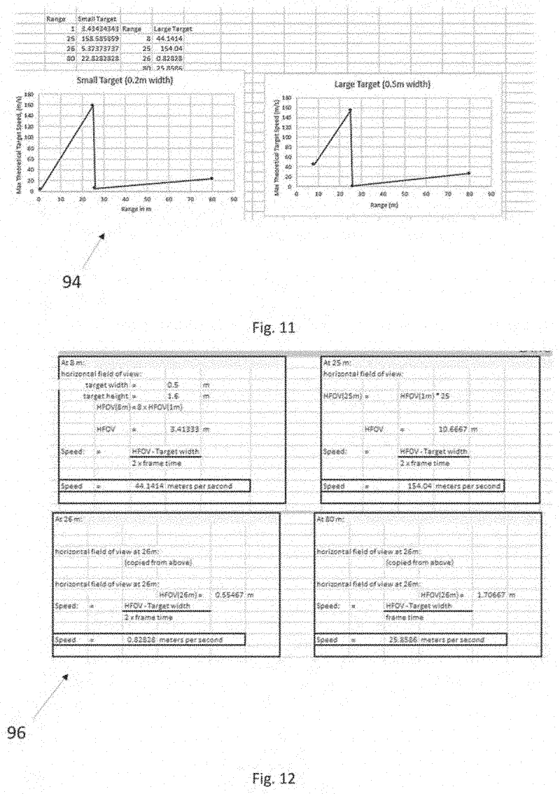

As shown in FIGS. 1 through 20, embodiments of the present design utilize a camera-based imaging device 15 secured to a firearm 20 to recognize a target and provide accurate measurement of shooter performance, enabling intelligent tutoring through the use of built-in tools. Camera-based technologies enable moving target engagement, and target engagement at extremely close range. Among other things, this provides a dry-fire close quarters battle capability.

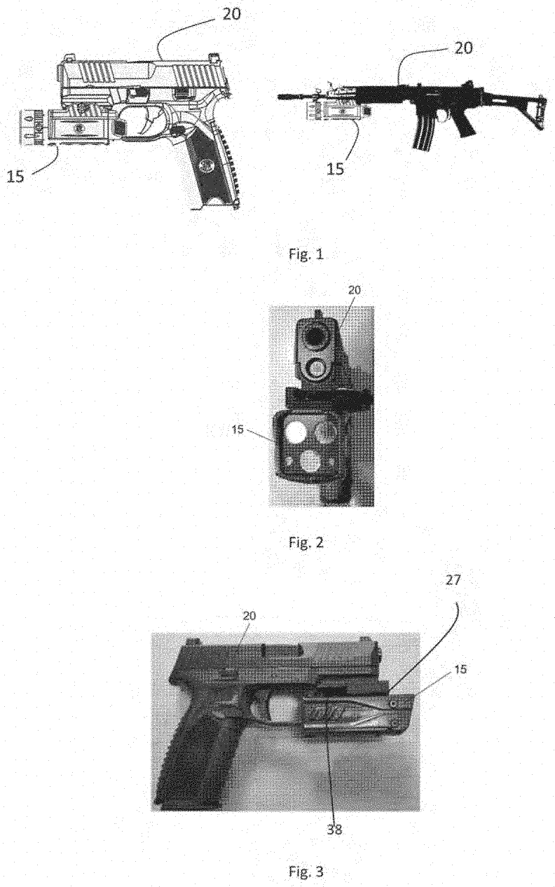

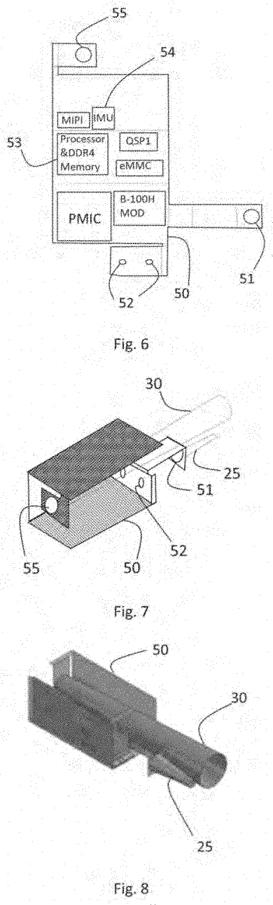

As shown in FIGS. 2 through 7, embodiments of the present design integrate multiple optical units/sensors, optimized for varying distances from the weapon. For example, a short-range optical sensor 25 and a long-range optical sensor 30 can be employed adjacent one another within a housing 35 of the camera-based imaging device 15, wherein the housing also contains a power supply such as batteries 40. In various embodiments, the housing 35 is formed with a rectangular prism element 36, a cylindrical element 37 and a platform element 38, wherein the platform element 38 can slidingly and lockingly engage a Picatinny rail 27 on a firearm. In this way, the housing 35 is held steady with the firearm 20. The cylindrical element 37 can house the sensors 25, 30 and the prism element 36 can house batteries and other components. As shown in FIGS. 6 and 7, the imaging device 15 can further include a printed circuit board (PCB) 50 to which a processor 53, memory, battery terminals 52, image sensors 51, 55 and other computing components can be secured for enabling the operations disclosed herein. A typical circuit according to the invention comprises:
Bluetooth 5.0, supporting wireless communication and encryption (same chipset as used in commercial smartphones);
Image sensors 51, 55, capturing images (still images (photos) and video streams) and presented by optics 25, 30;
A Graphics Processing Unit (GPU), which is a specialized electronic circuit designed to rapidly manipulate and alter memory to accelerate the creation of images in a frame buffer intended for output to a display device; supporting object recognition;
An Inertial Measurement Unit (IMU) 54, which is an electronic device that measures and reports body specific forces, angular rate and optionally the magnetic field surroundings the body, using a combination of accelerometers, gyroscopes and optionally magnetometers;
A master processor 53, providing onboard management of all functions and supporting onboard processing.

In order to reduce the dimensions of the electronics, the PCB 50 represented in FIGS. 6 to 8 is a rigid-flex circuit board. This circuit can be folded along the dotted lines represented in FIG. 6. The folded PCB is represented in FIG. 7, without the different elements on the PCB to improve clarity of the figure. FIG. 8 represents the PCB assembled with its optics 25, 30.

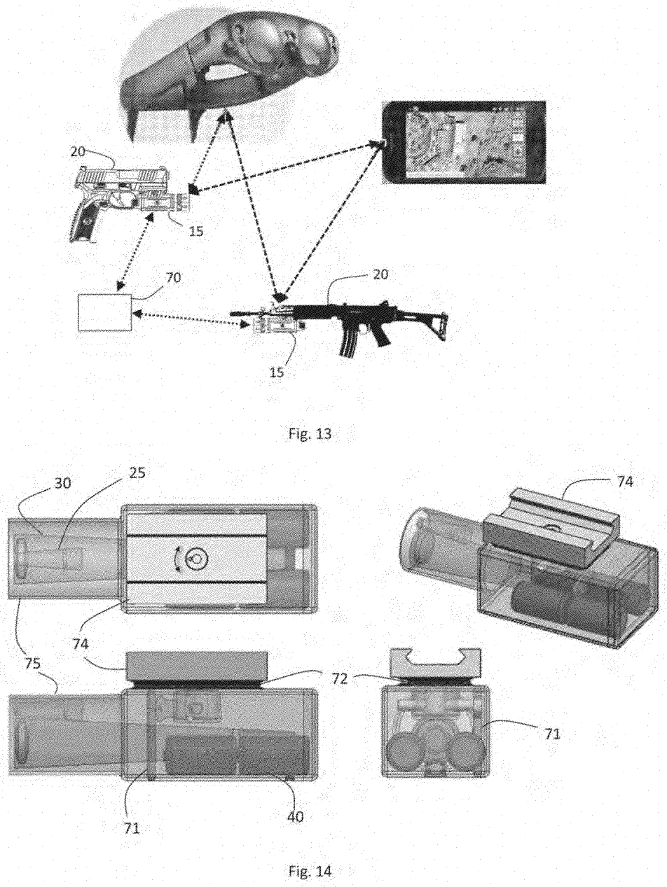

It will be appreciated that the housing 35 can be formed with different external shapes while accommodating the necessary internal components in order to have sufficient form and weight to enable the operation, storage and features described herein. The image processor stored in the housing 35 can interleave video streams from each optical unit 25, 30 to present the operator with a unified field of view. This field of view can be provided to the operator by means of a heads-up display 60, a handheld computing device 65 or a separate user interface on another computing device 70, for example, as illustrated in FIG. 13. In the background, the object recognition capability as disclosed herein can evaluate the individual video streams, applying object recognition applications to recognize and identify threats/targets within the effective range of each optical unit/image sensor. This enables real-time, rapid target identification across multiple distances and prioritization based upon the object recognition algorithm. Such object recognition, target display and priority display can be accomplished through suitable programming stored in memory and operable by the processor maintained within the housing 35. The display of targets and priorities can also be tailored to specific user communities and/or functional groups.

The target identification and recognition algorithm can either be directly integrated into the device 15 by means of fixing onto the firearm 20, or integrated in a wireless connected device such a heads-up display 60, a handheld computing device 65, or a separate user interface on another computing device 70. In this latter case, interleaved video streams or individual video streams are wirelessly sent to the remote device which makes the analysis.

In various embodiments, the weapon mounted imaging device 15 is small enough to be mounted on a pistol and rugged enough to operate on machine guns. Further, the device 15 can capture weapon position (GPS) and orientation (e.g., nine degrees of freedom (9 DOF)) and limited meteorological data. Additionally, the device 15 incorporates a camera capable of: 1) capturing shooter point of aim; 2) object (target) recognition; and 3) (live) moving target engagement metrics. The device 15 can capture large volumes of actual shooter performance data streams to enable development of intelligent tutoring capable of delivering tailored recommendations for training approaches for individuals, teams, and squads, thereby rapidly increasing training proficiency.

Examples of tailored recommendations include, for example, identifying the size of a shooter “aim box” measuring a shooter's stability in real-time. Such identification can enable the shooter to clearly quantify what he or she is doing incorrectly. By specifically identifying the symptom of a shooter's instability (e.g., triggering, breathing, sight alignment, etc.), the system enables the shooter to focus training on the specific weakness which is resulting in poor accuracy.

In various embodiments, the device integrates “artificial intelligence” into the chipset within the weapon system. This capability enables the weapon to “learn” how the shooter engages targets, provide training, and enhance accuracy in combat. The device can further integrate “computer vision” into the chipset within the weapon system. This capability enables the weapon to identify (e.g., via object recognition) targets, estimate range, and estimate speed of targets. This enables moving target engagement training, as well as supporting operational use. Such artificial intelligence can be accomplished through suitable programming stored in memory and operable by the processor maintained within the housing 35.

In various embodiments, a six-degrees of freedom (6 DOF) accelerometer/inertial measurement unit (IMU) is secured within the housing 35 to measure and track weapon position in relation to the target. It will be appreciated that the present device and system is interoperable with the Army IVAS head mounted display supporting augmented reality and can include position and location tracking to the weapon (real or surrogate) to provide position and location within the training environment. Additionally, the present system can track location using the Nett Warrior & Marine Common handheld communications devices.

Precise inertial measurement can for example be used to detect a movement of the firearm before the occurrence of a shot, and to wake up the electronics at an adequate timing before the occurrence of the shot. For example, the precise inertial measurement can be used to detect when a handgun is removed from a holster, or when a rifle is set or positioned on a probable shot position. This allows to record the entire sequence of the firearm use, thereby improving training capability.

As described elsewhere herein, the present system can leverage video generated from each optical unit/sensor to define threat/target movement. In specific embodiments, by quantifying (frame-by-frame) relative movement of the threat/target in relation to the operator point of aim. Such quantification can be accomplished through suitable programming stored in memory and operable by the processor maintained within the housing 35. This onboard capability provides the operator with direction and speed of movement of the threat/target enabling appropriate “lead” within point of aim to support accurate target engagement.

While static target training teaches good shooter mechanics, gunfighting or close combat engagement typically involves moving targets. The present system teaches users to successfully engage realistic moving targets (e.g., in dry-fire prior to moving to live training and/or operational engagements).

In various embodiments, the present system can be employed to assist with static shooter/moving target and moving shooter/moving target environments. Programming stored on the device 15 can apply algorithms that measure weapon orientation, cant, stability and shot break, for example. Another application can measure a shooter's ability to engage moving and static targets and can report specific shooter issues, generate performance metrics, and provide coaching tools.

By tracking operator dry-fire performance, the presently disclosed device can accurately predict outcomes during live-fire qualification events. Specifically, the device can accurately predict qualification scores on existing ranges based upon as few as ten dry-fire shots. Further, the system can support individualized training based on the identity of the shooter and their role within a given unit. This allows the system to “tune” expectations to novices (e.g., recruits, new personnel, CSS units), intermediate (e.g., riflemen, CS, support elements), and expert (e.g., SDM, sniper, competitive shooter, SNCOs). This ability to tailor metrics provides foundational support to intelligent tutoring as well as the ability to “rollup” individual performance within a team/squad to assess collective engagement skills.

It will be appreciated that the present device can be used dry-fire and live-fire. As a result, “reps & sets” in the company area can flow into qualification and other live fire events. This enables the quick diagnosis of what the shooter is doing differently on the range (as opposed to in the company area). Integration of the sensor at qualification enables intelligent tutoring and prescriptive remedial training without regard to how well the shoot scores. As a result, the focus becomes improvement and sustainment, rather than Go/No-Go qualification, for example.

With regard to the form, fit and function of the Pistol/Close Quarters Battle (PV/CQB) embodiment, the present device is modular, facilitates aiming and targeting in a dynamic environment and minimizes the amount of support equipment that is necessary to operate and sustain the product. Wireless communications between the device and an external user interface can be accommodated via Bluetooth, WiFi or other wireless communication protocol. It will be appreciated that the device's form factor can be constrained to ensure that it fits within a standard pistol holster. To avoid displacing the pistol flashlight, the device can incorporate both visible and invisible illumination and pointers. In various embodiments, the device is shock resistant to a one-meter drop and can withstand temperatures from −40 to +71° C. The device can be embodied so as to survive cleaning related to NRBC, using typical chemical treatment.

It will be appreciated that the present device enables delivery of new training modalities (e.g., mixed reality/augmented reality) without altering the hardware or software architecture. In various embodiments, a common software package is employed as a common baseline for Windows™, Android™ and iOS™ variants.

As shown in FIGS. 6 through 9, the device can be provided with embedded hardware including a high-end microcontroller dedicated to image processing. Software supporting target acquisition, identification, and other functions can be balanced between processing on the optical device and within the user interface (whether the user interface is a heads-up display, portable communications device or other device) to maximize system performance (speed) and minimize bandwidth requirements while still providing essential video and data.

In various embodiments, the device can function with dry fire, blank fire, live fire, simunition and simulated recoil during training without adjustment to system. The system can function for dry fire with “red” reset trigger training pistols: FN509 Red, Glock 17R.

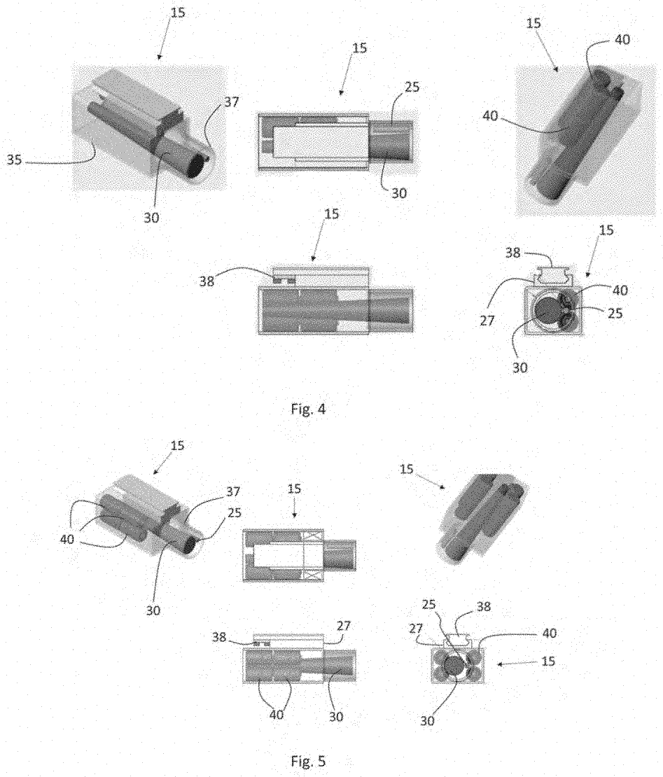

As shown in FIGS. 4, 5 and 14 through 18, batteries 40 can be provided for power to support continuous training.

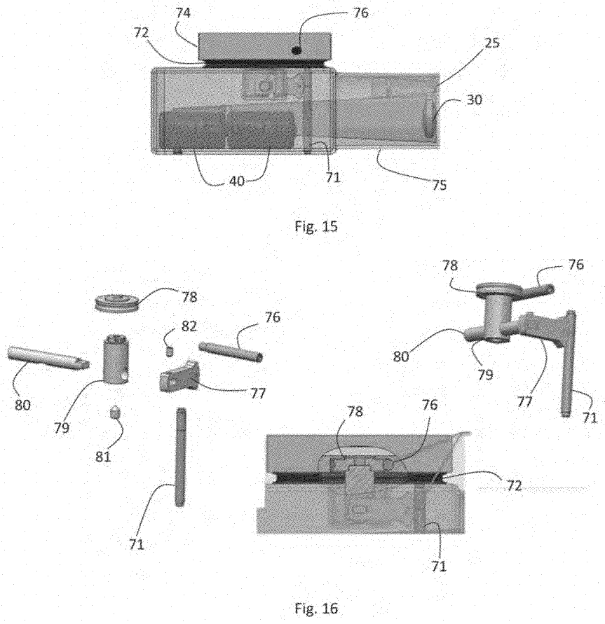

As shown in FIGS. 14 through 18 and as otherwise disclosed herein, the device can incorporate a unique external and/or a unique internal optic zeroing capability. Both capabilities deliver the ability to align the unit with the bore of the weapon. Independently and/or together, they provide the ability to provide rugged, enduring alignment. In a dedicated zeroing process within the software, the zeroing process enables the shooter to adjust the point of aim to coincide with sights on the device (e.g., using a static target). As shown in FIG. 15, the external optic zeroing capability can employ a windage adjustment 76 (worm gear) and a flexible bellows 72 between the Picatinny rail attachment 74 and the housing 75. This embodiment can further include elevation adjustment 71. FIG. 16 shows an exploded view of an external gimbaled worm gear design for external zeroing in accordance with embodiments of the present disclosure, including an arrangement where the worm gear is inherently self-locking. In the exploded view of FIG. 16, an elevation worm gear 71 is disclosed, wherein the elevation worm gear 71 is cooperating with an elevation gear fixed on a side of a support 79 supporting a windage gear 78, on which the Picatinny rail attachment 74 is fixed. The support 79 is fixed on the device 15 by an axis 80 rotating in elevation by the action of an elevation screw 71 on the elevation gear 77. For windage zeroing, the Picatinny rail attachment 74 is rotated by the action of the windage worm gear 76. The system is secured by a conical set screw 82 and a cup set screw 81.

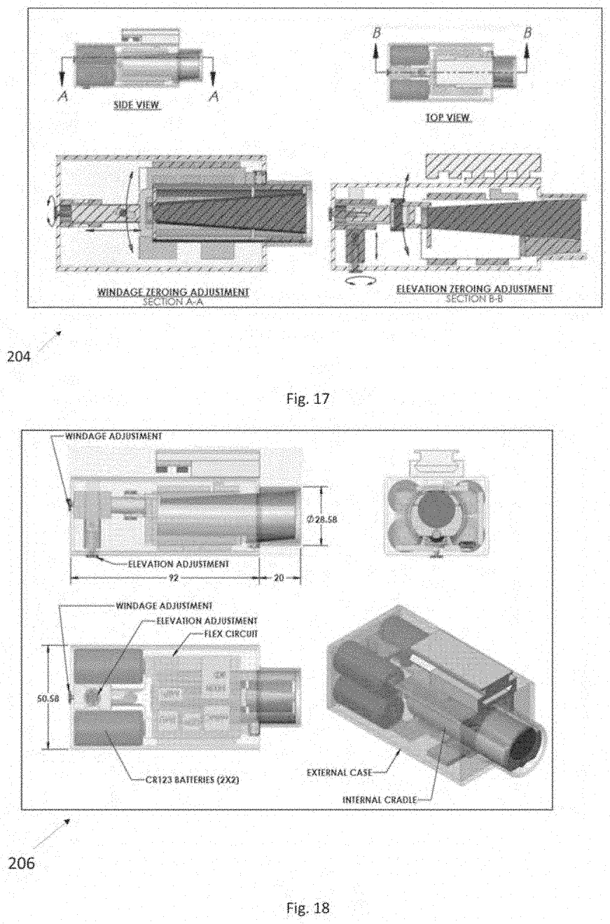

FIGS. 17 and 18 provide detailed diagrams, 204 and 206, respectively, regarding the elevation adjustment and windage adjustment for the internal optic zeroing capability in accordance with aspects of the present disclosure.

The system can work on devices using drop-in bolt(s), recoil simulators, UTM and Simunition. The system can further operate on surrogate/simulated weapons (e.g., Cybergun, Airsoft) using battery or CO2 power. The system can detect the presence of a magazine and magazine changes. The system can detect the user's position, and can calculate the user's time to draw, engage a target and fire the device. The system can further calculate the time it takes a user to complete a magazine change. The system can further detect when the device is removed from the holster.

As disclosed herein, the system can recognize targets based on predefined target images, such as may be stored in memory. In various embodiments, target identification is accomplished via software programming employed with the optical device. If needed, QR Code or other identification elements on targets can be provided as passive elements (e.g., stickers).

The system permits targets to be added or removed from the stored library. In combination with eyewear such as goggles, the system supports eye tracking. The system can digitally adjust the zoom automatically to the target and report shooter eye movement during target engagement. In various embodiments, the system incorporates an embedded image stabilization algorithm. The system can operate in standalone mode or in streaming mode and can record full streaming video. In various embodiments, the device streams the video to an end device and the operator can manually delimit the shape of the target.

The system is operable with, and can capture the shooter perspective, when employing an advanced combat optical gunsight (ACOG).

Augmented reality (AR) technologies can be employed with embodiments of the device of the present disclosure. In various embodiments, a Heads-Up Display (HUD/goggles) and/or the Nett Warrior device are integrated with the device. It will be appreciated that integration of these capabilities enables new training, operational, and logistics applications. For example, shooter marksmanship performance during live fire and dry fire can be shared and viewed.

Operator movement associated with acquiring the target can be recorded. The user interface can measure and present a graphic to see, for example, if a correct and quick position is taken before shooting.

In various embodiments, the device can be provided with multiple LED lights. For example, two bicolor (Red/Green) LED lights can be provided, wherein a first light turns green when power is ON but not recording or streaming and turns red when recording or streaming. The second light can detect and display level of battery charge remaining, where green indicates good charge and power remaining, amber indicates less than thirty minutes of remaining power and red indicates less than ten minutes of remaining power. To preserve battery life, the system can detect user inactivity and go into “sleep mode”.

In embodiments, the video of the training can start from an event call “Start”, which can be triggered in streaming mode when the operator initiates the “start session”. This can occur, for example, when the pistol is coming out of the holster after selecting this option in the software at the session level, or when the rifle/rifle/carbine is at an angle when targets are typically engaged after selecting this option in the software at the session level.

The Start can be triggered in standalone mode when the pistol is coming out of the holster, when the user pushes the pushbutton on the side of the device or when the rifle/rifle/carbine is at an angle when targets are typically engaged after selecting this option in the software at the session level. The operator can engage a target from the oblique (viewing angle 40° to 160°) and the user can adjust the oblique angle of engagement in the software.

In various embodiments, a shot trace is overlaid on a video of the target engagement and can register the movement three seconds before the shot break and one second following shot break in order to see the shooter's performance (e.g., breathing, holding, aiming, triggering). This can be performed by, for example, continuously recording the video streams and keeping in volatile memory only the last three seconds and storing these last three seconds in permanent memory upon detection of a shot.

In embodiments, 200 milliseconds prior to the shot will represent triggering, one second prior to shot break indicates point of aim and the preceding two seconds represents the stability of the shooter while engaging the target. The system can also generate an “aim box” using the same algorithms. The system can also capture one or more seconds of follow through. It will be appreciated that various modes of operation can affect the trace duration. For example, in a dynamic mode, the trace could be less than three seconds.

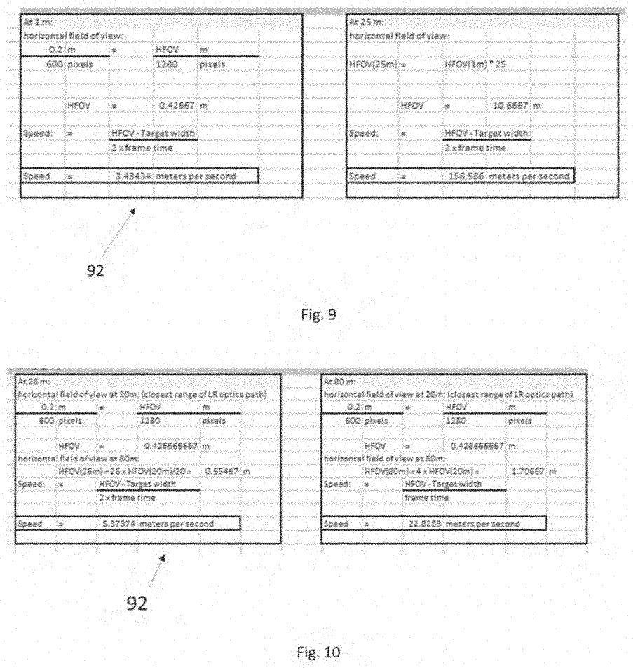

The system can record each shot that has been fired within a certain time frame (e.g., less than 100 ms). The system can also “recognize” targets based on imagery captured, such as, for example, an indicator such as a number or code printed on the target. The system can operate with targets of different size through all ranges. For example, “small” targets may be defined as NTM10 and/or 5×5 cm targets and “big” targets can be defined as human size to two humans separated by at least three cm. FIGS. 9 through 12 show diagrams 92, 94, 96, respectively, of moving target engagement algorithms that can be employed in accordance with embodiments of the present disclosure.

Based upon aggregated shooter data, the system can identify specific drills and/or corrective action to improve shooter mechanics. The system can support the export of all shooter metrics and recommended drills/corrective action to a database.

In embodiments, based on multiple (e.g., ten) shots in one or more shooting positions, the system can predict the shooter's probable qualification score and likely level of qualification. Based upon shots taken, and the grouping defined within the system, if appropriate, the system can recommend specific adjustments to mechanically zero the device.

In addition to the above, the system can support, score and “grade” predefined scenarios and events, such as multiple position, timed events, and magazine changes (these directly support qualification training events). The system can also support a user's ability to build a “script” which moves the shooter through various shooting positions and/or targets. For example, a script may provide a qualification scenario reflecting position and distance changes. The script may be saved and selected by the shooter for future training.

In various embodiments, the system is constructed so as to have a form resembling or similar in shape and size to the Streamlight TLR-1 or Surefire X300 weapon mounted flashlights, with the intent of fitting inside a flashlight compatible law enforcement retention holster.

The system can be mounted on a firearm and is compatible with pistols, rifles and carbines.

In various embodiments, the zeroing retention performances shall (separately) withstand four hundred rounds of ammunition (e.g., five and seven mm, and/or nine mm), while keeping accuracy within 0.5 minutes of angle (MOA). The optical unit can have an embedded laser pointer which can be independently turned off/on, wherein the pointer is not harmful to the eye. In various embodiments, the laser is capable of pointing to a target at fifty meters in sunlight condition (i.e., >35 mW).

The optical unit camera can be provided with an IR/night vision capability and can be provided with an illuminator such as a 300 lumen “flashlight” which can be independently turned off and on.

In various embodiments, the system supports up to four concurrent users on a single workstation, such that four different optical units can be in communication with a single user interface. The system can sense downrange imagery and weapon orientation with at least 6 DOF accuracy, according to various embodiments. The system can also sense temperature and barometric pressure through appropriate sensors. The system can further sense orientation of the device and can be provided with user adjustable settings to avoid false shot detection (e.g., by limiting shot recognition when the device is not oriented consistent with target engagement). The system can contain one or more push button(s) located on one side, for example, to control mechanical operations. It will be appreciated that buttons can be placed ergonomically in a manner that enables a shooter to touch buttons without removing his or her trigger hand and/or removing the device from his or her shoulder. It will further be appreciated that the device is operable when the user is wearing gloves.

In various embodiments, the weapon mounted sensor is designed to provide shooter telemetry data in support of training (e.g., Augmented Reality training—IVAS/HMD, operations and logistics applications). In embodiments, machine gun training (live and virtual) can be enabled by the weapon system as disclosed herein.

As noted elsewhere herein, the presently disclosed system creates a common hardware/firmware/software solution which supports training, operations and logistics applications. In specific embodiments, the capture and interpretation of telemetry data is “agnostic” and will be moved from the optical unit to local smart phone(s), computer(s), Head Mounted (augmented reality) Displays and/or local data stores which can communicate with the enterprise. By configuring the optical unit for “permanent” attachment to a weapon, weight/balance become part of the expectation during training and operations. Supporting the movement of the telemetry data to a wide range of local devices, training and operational data becomes useful for a wide range of applications, including logistics. Data streams from the weapon system (fire control, pptics, and other sensors) assist with collect large volumes of data on every shot taken (who is taking shot (biometrics), shooter location, speed of magazine change, position, meteorological data, target type, speed/direction of target, type of weapon, type of round, shot trace, hit/miss, score, lethality calculation, etc.). The present device supports emerging technological advancements which require integration of new sensors, the Head Mounted Display (HMD/goggles) and/or smart phones/personal digital assistants used by law enforcement and the military. Integration of these capabilities in association with current and next generation squad weapons enables new training operational and logistics applications.

In various embodiments, the local user interface enables operations and training in environments where an augmented reality head mounted display is not available. In addition, the user interface can support local coaching and observation of shooter performance. It will be appreciated that the present system can support individual training, small group coaching and competitive training by providing a local user interface that displays and stores shot-by-shot shooter performance. The user interface enables live training in a barracks, conference room, basketball court, etc., and enables shooter skills assessment, training level validation, and provides a “virtual gate” to higher levels of training as quantified by Army Integrated Weapon Training Strategy (IWTS), for example. In embodiments, the sensor connects with a local user interface to provide immediate shooter feedback, support intelligent tutoring, and provide coaching tools. The system can also share shooter data with an enterprise training management system, for example. The sensor promotes the evolution from individual weapon skills development to collective tasks, which, in turn, enhances squad lethality.

The presently disclosed system can employ an open development architecture that enables interoperability with parallel development by others, for example. In various embodiments, the presently disclosed system uses the Unity development platform, which provides immediate interoperability, and other critical and Augmented Reality Head Mounted Display capabilities. The present system can generate data and user interfaces accessible in Windows, Android, and iOS operating environments. In addition, the present system fully embraces integration of the Army Nett Warrior and/or Marine Common Handheld programs. Weapon platforms in accordance with the present disclosure can capture and prioritize information relevant to shooter engagement, situational awareness, weapon status (serviceability), and other applications relevant to reducing the burden on team/squad leaders.

Coaching tools embedded within the present system can automatically assess shooter mechanics (stability, point of aim, triggering, etc.) and identify where the user needs coaching. Leveraging the massive volume of shooter data generated by the use of the system, individually tailored intelligent tutoring can be delivered real time during marksmanship training. Examples of tailored recommendations include, for example, identifying the size of a shooter “aim box” measuring a shooter's stability in real-time. Such identification can enable the shooter to clearly quantify what he or she is doing incorrectly. By specifically identifying the symptom of a shooter's instability (e.g., triggering, breathing, sight alignment, etc.), the system enables the shooter to focus training on the specific weakness which is resulting in poor accuracy.

In various embodiments, two communication paths are supported between the weapon system and the local network: 1) Wireless (Bluetooth, a shorter distance wireless protocol, or a longer distance wireless protocol such as WiFi); and 2) USB direct wired connection.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more central servers, central controllers, or remote hosts; (b) one or more imaging devices with integrated optics and components as described herein; and/or (c) one or more personal computing devices, such as desktop computers, laptop computers, tablet computers or computing devices, personal digital assistants, mobile phones, and other mobile computing devices. A system as used herein may also refer to: (d) one or more imaging devices in combination with one or more central servers, central controllers, or remote hosts; (e) a single imaging device; (f) a single central server, central controller, or remote host; and/or (g) a plurality of central servers, central controllers, or remote hosts in combination with one another.

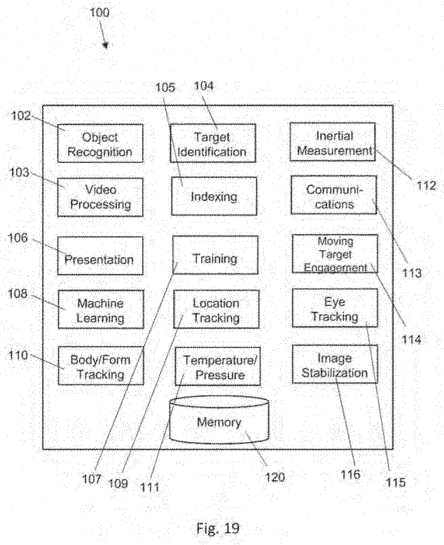

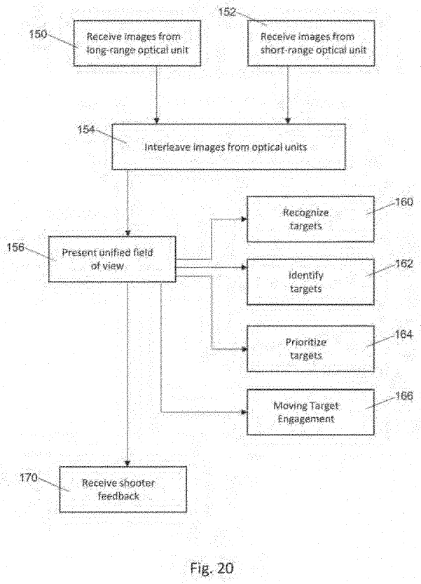

In such embodiments as described above, the device is configured to communicate with a central server, a central controller, a remote host or another device (such as a heads-up display or portable communications device) through a data network or remote communication link. As shown in FIG. 19, aspects of the present disclosure can be embodied in software or firmware for performing instructions as described herein. For example, the system 100 can employ object recognition component 102, video processing component 103, target identification component 104, indexing component 105, presentation component 106, training component 107, machine learning component 108, location tracking component 109, body/form tracking component 110, temperature and/or pressure sensor component 111, inertial measurement unit (IMU) 112, communications component 113, moving target engagement component 114, eye tracking component 115, image stabilization component 116 and memory 120. Each component performs operations as described herein. For example, object recognition component 102 can evaluate the individual video streams received from the optical units and processed by the video processing component, applying object recognition applications to recognize threats/targets within the effective range of each optical unit. The target identification component 104 can identify threats/targets within the effective range of each optical unit based on feedback from the object recognition component 102. The indexing component 105 can prioritize targets based on feedback from the target identification component 104. The presentation component 106 can execute instructions to present graphical displays on a variety of user interfaces such as the heads-up display, portable communication device or other computing device as described elsewhere herein. The training component 107 can operate with memory 120 to store and recall data for users to assist in training users, including augmented reality training as appropriate. The training component 107 can also assist with predicting outcomes and/or qualification scores, for example.

The machine learning component 108 enables the weapon to “learn” how the shooter engages targets, provide training, and enhance accuracy in combat. The location tracking component 109 enables the location of the device to be tracked. The body/form tracking component 110 detects and records the user's setup and positioning during training and operation. The temperature and/or pressure component 111 records temperature and/or pressure during operation. The IMU 112 detects relative positioning of the device. Communications component 113 facilitates communication between the device and external devices such as a heads-up display, portable communications device, and/or a central or remote computing device, for example. The moving target engagement component 114 executes algorithms to assist the user in engaging moving targets. As shown in FIG. 9, for example, this can involve frame-by-frame movement of the target to estimate speed and direction and can further involve comparing the shooter's position and orientation in relation to the target's speed and direction of movement to assess the shooter's lead. The eye tracking component 115 assesses eye movement of the user and the image stabilization component 116 assists with image stabilization. Memory 120 stores data and programming relevant to all of the operations described herein.

As shown in FIG. 20, the system can operate according to at least one process as at 150 and 152 to receive images from the long-range and short-range optic devices, respectively. As at 154, the system can execute instructions to interleave the images from the optical units. As at 156, the system presents a unified field of view on one or more of the displays or user interfaces as described herein. The field of view can include content produced as a result of recognizing targets in the image(s) as at 160, identifying the recognized targets as at 162, prioritizing the identified and/or recognized targets as at 164 and determining speed and direction of a moving target via moving target engagement operations in accordance with the present disclosure, as at 166. It will be appreciated that, due to the multiple optic devices, the system can present multiple targets in the field of view. Depending upon shooter operation in response to the content depicted in the field of view, the system can receive shooter feedback as at 170. Such feedback can be used for training or real-time feedback for use in actual events. Other aspects of operation as described herein can be involved in the processes depicted in FIG. 20.

It will thus be appreciated that embodiments of the present disclosure provide, in part, a method, device and system for recognizing multiple targets at varying distances and orientations, comprising some or all of:

a firearm;

a camera-based imaging device secured to the firearm, wherein the imaging device comprises multiple optical units/sensors;

a computer processor; and

a computer-readable memory and program instructions encoded by the computer-readable memory for causing the processor, when executed, to perform steps comprising:

recognizing one or more targets via the imaging device; assigning priority to the one or more targets based on risk; and

interleaving video streams from the multiple optical units/sensors.

It will further be appreciated that the embodiments of the present disclosure provide, in part, a method, device and system for weapons skill development, comprising some or all of:

a firearm;

a camera-based imaging device secured to the firearm, wherein the imaging device comprises multiple optical units/sensors;

a computer processor; and

a computer-readable memory and program instructions encoded by the computer-readable memory for causing the processor, when executed, to perform steps comprising:

recognizing one or more targets via the imaging device; and

quantifying relative movement, such as frame-by-frame, of the target in relation to the point of aim of a firearm operator.

It will be appreciated that the embodiments of the present disclosure further provide, in part, a method, device and system for marksmanship training, comprising some or all of:

a firearm;

a camera-based imaging device secured to the firearm, wherein the imaging device comprises multiple optical units/sensors;

a computer processor; and

a computer-readable memory and program instructions encoded by the computer-readable memory for causing the processor, when executed, to perform steps comprising:

track operator dry-fire performance of the firearm;

measure shooter performance and recommend one or more strategies or drills to enhance skill of the operator; and

accurately predict outcomes for the operator during live-fire qualification events.

It will be appreciated that the embodiments of the present disclosure further provide, in part, a method, device and system for optic zeroing, comprising some or all of:

a firearm;

a camera-based imaging device secured to the firearm, wherein the imaging device comprises multiple optical units/sensors;

internal or external optic zeroing components as described herein;

a computer processor; and

a computer-readable memory and program instructions encoded by the computer-readable memory for causing the processor, when executed, to perform steps comprising:

enabling an operator to adjust the point of aim of the firearm to coincide with sights on the firearm.

In certain embodiments in which the system includes a firearm and imaging device in combination with a central server, central controller, or remote host, the central server, central controller, or remote host is any suitable computing device (such as a server) that includes at least one processor and at least one memory device or data storage device. As further described herein, the imaging device can include at least one device processor configured to transmit and receive data or signals representing events, messages, commands, or any other suitable information between the imaging device and other devices, which may include a central server, central controller, or remote host. The imaging device processor can be configured to execute the events, messages, or commands represented by such data or signals in conjunction with the operation of the imaging device. Moreover, the processor of the additional device, central server, central controller, or remote host is configured to transmit and receive data or signals representing events, messages, commands, or any other suitable information between the central server, central controller, or remote host and the additional device. One, more than one, or each of the functions of the central server, central controller, remote host or other devices may be performed by the processor of the imaging device. Further, one, more than one, or each of the functions of the imaging device processor may be performed by the at least one processor of the central server, central controller, remote host or other device.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one geolocation module 1076 is configured to acquire geolocation information from one or more remote sources and use the acquired geolocation information to determine information relating to a relative and/or absolute position of the device. For example, in one implementation, the at least one geolocation module 1076 is configured to receive GPS signal information for use in determining the position or location of the device. In another implementation, the at least one geolocation module 1076 is configured to receive multiple wireless signals from multiple remote devices (e.g., devices, servers, wireless access points, etc.) and use the signal information to compute position/location information relating to the position or location of the device.

The at least one user identification module 1077 is configured to determine the identity of the current user or current owner of the device. For example, in one embodiment, the current user performs a login process at the device in order to access one or more features. Alternatively, the device is configured to automatically determine the identity of the current user based on one or more external signals, such as an RFID tag or badge worn by the current user and that provides a wireless signal to the device that is used to determine the identity of the current user. In at least one embodiment, various security features are incorporated into the device to prevent unauthorized users from accessing confidential or sensitive information.

1. Method for analyzing a firearm shot, comprising the steps of:
i. providing a firearm comprising a camera-based imaging device and a computer processor;
n. recording images in the direction of the point of aim of the firearm;
iii. recognizing one or more targets via the imaging device;
iv. analyzing the correspondence between the recognized target and the point of aim at the time of a shot.

2. The method according to claim 1, wherein the camera-based imaging device comprises at least two optical sensors having lenses of different focal length for acquiring images in the direction of the point of aim having different field of view, the method further comprising the step of interleaving video streams originating from the at least two optical sensors.

3. The method according to claim 1, comprising the step of recording the movement of the point of aim relative to the target prior and after the detection of a shot.

4. The method according to claim 1, comprising the step of communicating real-time data to a head-up display, said real-time data comprising at least one of data selected from the group consisting of: point of aim, recognized target, target speed, target orientation, target scale factor, target range estimation, appropriate lead taking into account target speed, and lethality of the current point of aim.

5. The method according to claim 1, further comprising the step of collecting additional data on every detected shot, said data being related to an operator of the firearm, one or more of said data being selected from the group consisting location and movement of the firearm, speed of magazine changes, orientation, meteorological data, target type, speed/direction of target, type of weapon, type of round, shot trace, hit/miss, score, intended target, and lethality calculation.

6. The method according to claim 1, comprising the step of quantifying relative movement of the target in relation to the point of aim of the firearm and calculating the appropriate lead within the point of aim to support accurate moving target engagement.

7. The method according to claim 1, comprising the step of detecting the occurrence of a shot, and determining the point of impact on the recognized target, by calculation of the ballistic and/or by determining the point of impact of a bullet.

8. The method according to claim 7, further comprising the step of aligning the optical sensor axis with the bore axis by using a comparison between the calculated point of impact with the point of impact of the bullet.

9. The method according to claim 1, comprising the step of communicating the recorded images to at least one remote device, said remote device being used to communicate performance of a user of the firearm.

10. The method according to claim 1, wherein the step of acquiring a target is based on the recognition of predetermined shapes in training conditions.

11. The method according to claim 1, wherein the step of acquiring a target is based on a human body pose determination algorithm.

12. The method according to claim 1, said method being used in a training environment.

13. The method according to claim 1, further comprising the step of switching the camera-based imaging device and the computer processor upon detection of predetermined action of a user of the firearm, such as getting a handgun out of a holster or removing a safety feature.

14. A firearm shot analysis system comprising:
a) a camera-based imaging device comprising fastening means to a firearm;
b) a computer processor, power supply and memory for recording the images acquired by the camera-based imaging device; and
c) a computer-readable memory and program instructions encoded by the computer-readable memory for causing the processor, when executed, to perform the method according to any of the previous claims except step i.

15. The firearm shot analysis system according to claim 14, wherein the imaging device comprises multiple optical units/sensors.

16. The firearm shot analysis system according to claim 14, comprising wireless communication means.

17. The firearm shot analysis system according to claim 14, comprising an inertial measurement unit that collects the weapons movement, shot break detection and analysis.

18. The firearm shot analysis system according to claim 14, comprising localization means such as GPS.

19. The firearm shot analysis system according to claim 14, characterized in that the fastening means are compatible with a Picatinny rail.

20. The firearm shot analysis system according to claim 15, wherein the image sensors, the computer processor and the memory are located on a single folded rigid flex printed circuit board forming a cavity enclosing active elements.

21. A firearm comprising the system according to claim 14.

22. A firearm according to claim 21, wherein the firearm is a handgun fitting in a standard handgun holster.

23. A firearm according to claim 22, wherein the firearm is an automatic rifle.
